(19) United States
(12) Patent Application Publication
(10) Pub. No.: US 2022/0033946 A1
(43) Pub. Date: Feb. 3, 2022

(54) COMPOSITION DESIGN OPTIMIZATION METHOD OF ALUMINUM ALLOY FOR SELECTIVE LASER MELTING

(71) Applicant: CENTRAL SOUTH UNIVERSITY, Changsha Hunan (CN)

(72) Inventors: Zhiyong CAI, Changsha Hunan (CN); Richu WANG, Changsha Hunan (CN)

(21) Appl. No.: 17/386,202

(22) Filed: Jul. 27, 2021

(30) Foreign Application Priority Data
Jul. 28, 2020 (CN) 202010738545.8

(51) Int. Cl. C22F 1/04; C22F 1/00; B33Y 50/02; B33Y 70/00; B33Y 40/20; B22F 10/64; B22F 10/28; B33Y 10/00; B23K 26/34

(52) U.S. Cl. CPC C22F 1/04; C22F 1/002; B33Y 50/02; B33Y 70/00; B22F 2301/052; B22F 10/64; B22F 10/28; B33Y 10/00; B23K 26/34; B33Y 40/20

(57) ABSTRACT

A composition design optimization method of aluminum alloy for selective laser melting, including the following steps: S1: making alloy ingots with different composition; S2: pre-treating and processing the alloy ingots to obtain alloy sample blocks with different composition; S3: twice laser surface scanning treatment; S4: treating the alloy sample blocks by induction heating and quenching; S5: inspecting surface morphology, microstructure and properties of second laser melting layer of each alloy sample block, to determine whether the alloy sample blocks are suitable for selective laser melting process and optimize alloy composition.

### CROSS REFERENCE TO RELATED APPLICATIONS

This application claims priority to Chinese Application No. CN 202010738545.8 having a filing date of Jul. 28, 2020, the entire contents of which are hereby incorporated by reference.

### FIELD OF TECHNOLOGY

The following relates to a composition design optimization method of aluminum alloy, in particular to a composition design optimization method of aluminum alloy for selective laser melting.

### BACKGROUND

Additive Manufacture technology, also known as 3D printing, is based on the principle of discrete-stacking. According to the 3D CAD slice model data of the parts, the three-dimensional metal parts with high performance and density close to 100% can be directly formed, and prototype parts with no margin can be manufactured quickly. With the continuous development of industrial design, the structure of parts is more and more complex, and the requirements for its accuracy are getting higher and higher. Therefore, the competitiveness of additive manufacturing technology in today's manufacturing industry is expanding, and it is also a key breakthrough of new material manufacturing technology at home and abroad. Selective laser melting (abbreviated as SLM) is a major technical approach in metal material additive manufacturing technology. It uses high-energy lasers as energy sources, the metal powder bed is scanned layer by layer following the planned path in the 3D CAD slice model, the scanned metal powder is melted, rapidly cooled and solidified to form, and finally metal parts with high-density and high-precision are created. Currently, the materials that can be used in selective laser melting include titanium alloy, high temperature alloy, aluminum alloy, stainless steel and alloy thereof.

However, due to the large differences in the compositions and ratios of different alloy materials, there are also large differences in their forming properties. Therefore, the alloy material systems suitable for selective laser melting are quite limited. For example, some alloys are easy to oxidize, with poor fluidity, prone to agglomeration when powder spreading, and have excessively high laser emissivity and thermal conductivity, which makes the selective laser melting of these alloys more difficult. Therefore, it is particularly important to analyze and screen the composition and ratio of alloy materials, and determine whether they belong to a material system suitable for selective laser melting.

In the known art, methods for analyzing and screening alloy composition are disclosed in Paper (1) Selective laser sintering/melting (SLS/SLM) of pure Al, Al—Mg, and Al—Si powders: Effect of processing conditions and powder properties (Journal of Materials Processing Technology, 2013, 213: 1387), Paper (2) Evaluation of an Al—Ce alloy for laser additive manufacturing (Acta Materialia, 2017, 126: 507) and Paper (3) Microstructures and mechanical property of AlMgScZrMn: A comparison between selective laser melting, spark plasma sintering and cast (Materials Science and Engineering: A, 2019, 756: 354). The methods usually include following steps: selecting alloy, smelting alloy, atomizing alloy to powder, screening powder, molding via selective laser melting, and then studying the formability, microstructure and performance of the resulting material to decide whether the alloy composition is suitable for the forming technology of selective laser melting. However, the alloy composition screening through the above steps not only requires a long experimental period, but also costs lot, which limits its wide application.

At present, the team of Professor Wu Xinhua of Monash Centre for Additive Manufacturing has proposed an alloy development method for selective laser melting based on sample surface melting (“Selective laser melting of a high strength Al—Mn—Sc alloy: Alloy design and strengthening mechanisms. Acta Materialia, 2019, 171: 108” and “Towards a high strength aluminum alloy development methodology for selective laser melting [J]. Materials & Design, 2019, 174: 107775”). This method only observes the formability and microstructure of the surface of an alloy sample, which can shorten the developing cycle of alloys for selective laser melting to a certain extent. However, the structure and thermal history of the sample are quite different from that of the actual parts formed via the selective laser melting process, resulting in a large deviation in the evaluation of the alloy formability. And there is no correlation between the performance of the surface melting layer and that of the alloy in selective laser melting.

Therefore, it is urgent to develop a composition design optimization method of alloy for selective laser melting, which can accurately simulate the thermal history and microstructure evolution of the actual selective laser melting process and shorten the alloy materials screening and optimization period.

### SUMMARY

An aspect relates to an efficient and low-cost method for designing and optimizing composition of aluminum alloy for selective laser melting. This method can simulate the thermal history of the actual selective laser melting process, and the melting and solidification process is similar to that of the selective laser melting, so that the optimization results of alloy composition screening are more accurate, which can shorten the optimization period of alloy materials selection.

The technical scheme in embodiments of the disclosure is as follows:
A composition design optimization method of aluminum alloy for selective laser melting, including the following steps:
S1: preparing raw materials according to different designed formulas, and making alloy ingots with different composition;
S2: pre-treating and processing the alloy ingots to obtain alloy sample blocks with different composition;
S3: using high-energy laser beam perform on surface of each alloy sample block for first laser scanning to form a first laser melting layer on the surface thereof, then using high-energy laser beam again to perform on area of the first laser melting layer for second laser scanning to form a second laser melting layer;
S4: treating the alloy sample blocks from the step S3 by induction rapid heating and quenching;
S5: inspecting surface morphology, characterizing and testing microstructure and properties of the second laser melting layer of each alloy sample block from the step S4, to determine whether the alloy sample blocks are suitable for selective laser melting process and optimize composition of the alloy sample blocks.

Compared with the known art, the composition design optimization method of the disclosure adopts two laser surface scanning processing combined with induction rapid heating, according to the characteristics of the alloy material's melting, solidification and thermal history in the process of selective laser melting, making the microstructure of the second laser melting layer on the surface of the alloy sample block closer to the alloy powder that is rapidly solidified during the selective laser melting process, and at the same time, the thermal stress of the laser melting layer is closer to the thermal in the selective laser melting process, thereby simulating the state of alloy material in the process of selective laser melting. Then the obtain second laser melting layer thereon is inspected and analyzed, and its microstructure performance is tested, so as to accurately analyze and decide whether the composition of the alloy sample block is right for selective laser melting forming technology. In addition, the composition design optimization method of the present disclosure has simple steps, directly analyzing the alloy ingot without making it to powder, which simplifies the screening and optimization steps, and can perform rapid evaluation of multiple alloy ingots at the same time, realizing a highly efficient alloy composition design optimization for selective laser melting, which provides a new idea and new method in the area thereof.

In some embodiments, in the step S3, when the alloy sample blocks are completely cooled after the first laser scanning, the second laser scanning is performed. The effect of the first laser scanning is to obtain a small rapidly solidified microstructure that is similar to the microstructure of aerosolized powder, so as to obtain original conditions similar to selective laser melting, including alloy microstructure and thermal conditions. After that, the second laser scanning is performed to obtain a microstructure similar to that of powder after selective laser melting.

In some embodiments, in the step S3, a center of the laser beam of the second laser scanning is scanned along centers of two molten pools formed in the first laser melting layer. Thus, the heating, solidification and stress conditions similar to those of selective laser melting forming can be obtained to evaluate the laser formability of the alloy, and the scanning strategy can be set according to the specific alloy composition.

In some embodiments, in the step S3, before the first laser scanning, the surface of each alloy sample block is subjected to laser scanning pretreatment, and then process parameters of the first laser scanning and the second laser scanning are determined by observing state of a laser surface melting layer obtained by the laser scanning pretreatment. Before the first laser scanning, the appropriate laser scanning parameters are firstly decided by inspecting the state of the laser surface melting layer obtained by the laser scanning pretreatment, and the correlations between the morphology of the laser melting layers of the alloy ingots with different compositions and the process parameters are obtained, to provide a basis for the process parameters optimization for the surface laser scanning, and the process parameters of the first laser scanning and the second laser scanning are the same.

In some embodiments, in the step S3, steps of the first laser scanning and the second laser scanning comprise: placing the alloy sample blocks in prefabricated fixtures of a selective laser melting equipment, and setting scanning speed to 10-600 mm/s, laser power to 50-300 W, and scanning spacing to 0.05-0.1 mm for scanning. The first laser scanning can eliminate coarse casting structure in the alloy sample block, so that the microstructure of the alloy sample block is close to that of aerosolized powder.

In some embodiments, in the step S3, the prefabricated fixtures can be nine or sixteen grooves machined on a substrate of the selective laser melting equipment, matching dimensions of the alloy sample blocks, with a height of 2 mm.

In some embodiments, the step S4 specifically comprises: transferring the alloy sample blocks from the step S3 to a high-frequency induction furnace, using the high-frequency induction furnace for rapid heating with a heating temperature of 450-550° C., and holding time of 5˜60 seconds, and quenching the alloy sample blocks with water to room temperature after holding. The alloy sample blocks are quickly heated in the high-frequency induction furnace and quickly transferred from the furnace to water quenching, and the transfer time is about 1 s, which can ensure that the alloy sample blocks can be quenched to room temperature quickly after holding, so as to reduce the coarsening of microstructure.

In some embodiments, in the step S1, making each alloy ingot comprises: preparing raw materials, mixing pure metals, master alloys and smelting aids, and then smelting to obtain an alloy melt; a method of smelting is any one of resistance furnace smelting, induction smelting, and vacuum smelting; then casting the alloy melt with a mold with a flat cavity to form a slab-shaped alloy ingot. The use of the mold with the flat cavity for casting can reduce the composition segregation in the microstructure of the alloy ingot and reduce subsequent processing work amount.

In some embodiments, in the step S2, pre-treating and processing each alloy ingot comprises: homogenizing the alloy ingot, and then processing and cutting the alloy ingot to form a round alloy sample block with a thickness of 5-10 mm and a diameter of 20-30 mm.

In some embodiments, in the step S5, according to cracking degree, pore size, morphology and microstructure uniformity of the second laser melting layer of each alloy sample block, whether the alloy sample block with designed formula is suitable for selective laser melting process is evaluated, and microstructure and properties of the second laser melting layer of the alloy sample block and alloy powder with the same formula after selective laser melting are compared, to optimize composition of aluminum alloy for selective laser melting process.

For a better understanding and implementation, embodiments of the disclosure will be described in detail below in combination with accompanying drawings.

### BRIEF DESCRIPTION OF THE DRAWINGS

FIG. 1 is a flow diagram of a composition design optimization method of aluminum alloy for selective laser melting according to some embodiments of the disclosure;

FIG. 2 is a flow diagram of comparative experiment of a composition design optimization method of aluminum alloy for selective laser melting according to some embodiments of the disclosure;

FIG. 3 shows surface morphology of 2024 aluminum alloy sample block scanned by laser in Embodiment 1;

FIG. 4 shows microstructure of Al-5Mg-0.3Mn-0.6Sc-0.4Zr alloy sample block scanned by laser in Embodiment 2;

FIG. 5 shows microstructure of Al-5Mg-0.3Mn-0.6Sc-0.4Zr alloy powder after selective laser melting in Embodiment 2;

FIG. 6 shows relationship curves between microhardness and Mg content of the Al-xMg-0.3Mn-0.6Sc-0.4Zr alloy sample blocks scanned by laser and the Al-xMg-0.3Mn-0.6Sc-0.4Zr alloy powder after selective laser melting in Embodiment 2; and

FIG. 7 is a processing flow chart of alloy material in a composition design optimization method according to some embodiments of the disclosure.

### DETAILED DESCRIPTION

When studying alloy materials right for selective laser melting technology, the applicant has found that in the known art, the methods for selecting suitable alloys are usually to obtain alloy powder through a series of steps such as alloy selection, smelting, atomization powder process, screening powder and so on. The alloy powder is then subjected to selective laser melting forming. During the process of selective laser melting forming, it is decided whether the alloy composition is appropriate, so as to optimize the alloy composition. However, the research period of this method is too long and also faces high production costs.

The applicant hopes to simplify the process of alloy optimization and thus shorten the research period, especially the complex process of atomization and powder screening. The applicant has conceived an alloy composition design optimization method without the preparation of alloy powder, which takes an alloy ingot as the research object, that is, observing the surface of the alloy ingot and testing its microstructure and properties, so as to judge whether the composition of the alloy ingot is suitable for selective laser melting. However, because the alloy ingot and the alloy powder are the research objects in two different states, the microstructure and thermal history of the two are quite different, that is, the untreated alloy ingot is quite different from the alloy powder in actual selective laser melting process, which leads to a large deviation in the evaluation of the alloy formability.

Therefore, the applicant further proposes a composition design optimization method of aluminum alloy for selective laser melting, which uses two laser surface scanning treatments and induction heating to process an alloy sample block, so that its microstructure and thermal stress are closer to the rapidly solidified alloy powder in the selective laser melting process, and the subsequent evaluation and analysis results of the applicability of the alloy sample block material are more accurate.

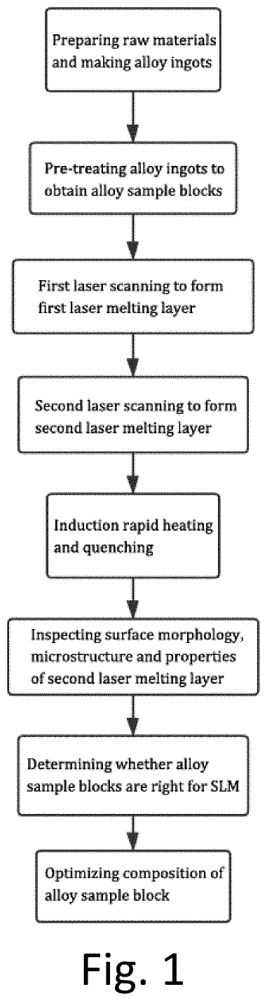

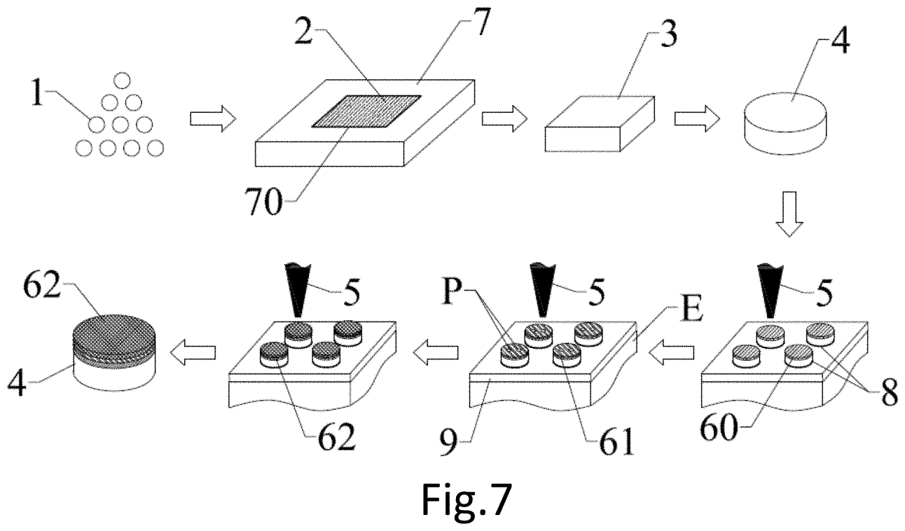

Referring to FIG. 1 and FIG. 7, the composition design optimization method includes the following steps:

S1: Preparing raw materials 1 according to different designed formulas, and then making alloy ingots 3 with different composition.

Step S1 specifically includes: according to the designed formula of alloy, raw materials 1 including pure metal, master alloys, smelting additives, etc., are weighed and fully mixed for smelting to prepare an alloy melt 2. The smelting method can be any one of resistance furnace smelting, induction smelting and vacuum smelting. The alloy melt 2 is then cast in a mold 7 with a flat cavity 70, such as a copper mold or a water-cooled mold, to form an ingot of alloy. Preferably, the alloy ingot 3 is slab-shaped, with a thickness greater than 10 mm and a weight less than 200 g.

S2: Pre-treating and processing the alloy ingots 3 to make alloy sample blocks 4 with different composition.

In step S2, the steps of pre-treating and processing include homogenization treatment and machining and cutting treatment. Specifically, the homogenization treatment includes heating, heat preservation, cooling and other steps to change and homogenize the microstructure and properties of the alloy ingots 3. Machining and cutting treatment is to process the surface of each alloy ingot 3 by means of turning, milling and fine carving, and finally an alloy sample block 4 is obtained, so that the upper and lower surfaces thereof are smooth and have a certain roughness, thus reducing the reflection of laser on smooth surface, improving the efficiency of laser scanning.

S3: Twice laser surface scanning treatment on the alloy sample blocks 4.

In step S3, the processing parameters of the two laser scanning are set according to the different composition of the alloy sample blocks 4, wherein the parameters for the first laser scanning and the second laser scanning are as follows: scanning speed 10-600 mm/s, laser power 50-300 W, scanning spacing 0.05-0.1 mm. The alloy sample blocks 4 are placed in prefabricated fixtures 8 of a selective laser melting equipment E. The first laser scanning is carried out on the surfaces of the alloy sample blocks 4, using high-energy laser beam 5, to form a first laser melting layer 61 on the surface of each alloy sample block 4. After the first laser scanning, when the alloy sample blocks 4 are completely cooled, the second laser scanning is carried out on the area of the first laser melting layer 61 by high-energy laser beam 5, and the center of the laser beam 5 of the second laser scanning is along the centers of the two molten pools P formed in the first laser melting layer 61, to form a second laser melting layer 62. The prefabricated fixtures 8 can be nine or sixteen grooves 8 machined on a substrate 9 of the selective laser melting equipment E, matching dimensions of the alloy sample blocks, with a height of 2 mm.

Please note that before the first laser scanning, each alloy sample block 4 can be pretreated by surface laser scanning to obtain a laser surface melting layer 60, and then the state of the obtained laser surface melting layer 60 is inspected to decide the process parameters for the subsequent first laser scanning and the second laser scanning.

S4: Treating the alloy sample blocks 4 from step S3 by induction rapid heating and quenching.

In step S4, a high-frequency induction furnace is used for rapid heating, the heating temperature is 450-550° C., and the holding time is 5-60 seconds. After the holding is completed, the alloy sample blocks 4 are quickly quenched with water to room temperature.

S5: Inspecting surface morphology, characterizing and testing microstructure and properties of the second laser melting layer 62 of each alloy sample block 4 from step S4, to determine whether the alloy sample blocks 4 are suitable for selective laser melting process and optimize alloy composition.

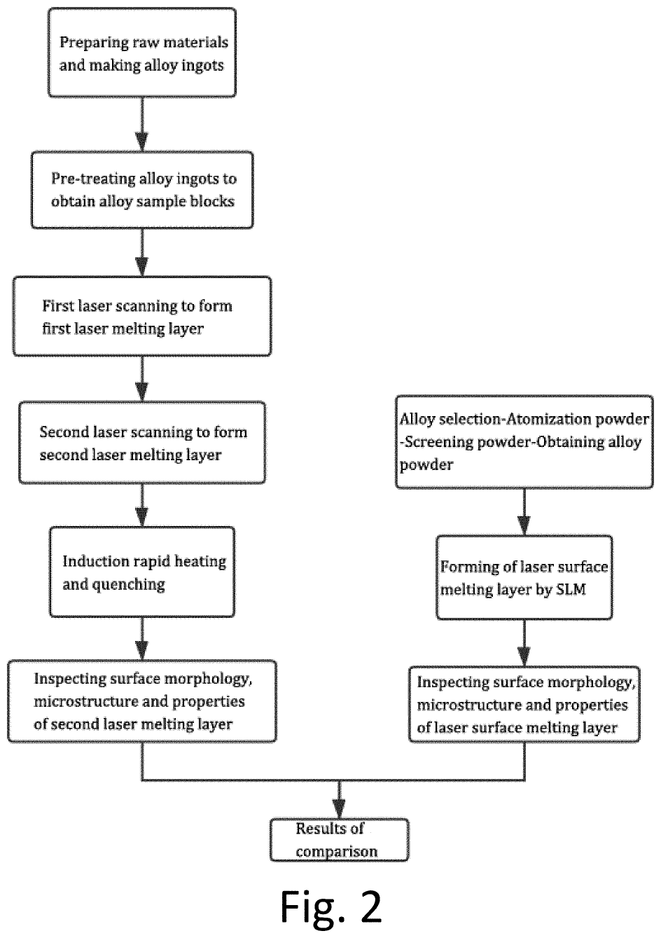

Step S5 specifically includes: the surface morphology of the second laser melting layer 62 of each alloy sample block 4 from step S4 is inspected by metallographic microscope, scanning electron microscope and energy spectrometer. The microstructure and properties of the second laser melting layer 62 are characterized and tested by the methods of microhardness and micro-nano stretching. According to cracking degree, pore size, morphology and microstructure uniformity of the second laser melting layer 62 of each alloy sample block 4, whether the alloy sample block 4 with designed formula is suitable for selective laser melting process is evaluated. In addition, the microstructure and properties of the second laser melting layer 62 of the alloy sample block 4 are compared with those of the vacuum atomized powder of the alloy sample block 4 in selective laser melting process, to optimize the composition of the alloy sample block 4 for selective laser melting of aluminum alloy. Please refer to FIG. 2.

The composition design optimization method for selective laser melting of the disclosure will be further described following in detail by Embodiments 1-4.

### Embodiment 1

This embodiment is to verify whether the laser forming performance of 2024 aluminum alloy is suitable for selective laser melting process, including the following steps:

S1: Preparing 2024 aluminum alloy ingots from the raw materials.

The specific composition of 2024 aluminum alloy is Al-4.4Cu-1.5Mg-0.6Mn-0.08Ti, and the raw materials include pure aluminum ingots, pure magnesium ingots, Al-50Cu master alloy, Al-13Mn master alloy and Al-5Ti—B master alloy.

Step S1 includes: according to the formula of 2024 aluminum alloy, melt the pure aluminum ingots in a resistance furnace at a temperature of 800-850° C., then add other raw materials thereto, fully stir by a graphite rod for 5-15 minutes, put a flux composed of 30% NaCl+47% KCl+23% cryolite in a graphite cover, extend it into the bottom of the melt for slagging, use hexachlorohexane for degassing, then cool to 700-750° C. and add 1-2% grain refiner of Al-5Ti—B, then stand for 5-10 minutes, use a copper mold whose inner surface is pre-coated with a layer of ZnO for casting to form eight 2024 aluminum alloy ingots, and finally process and cut the 2024 aluminum alloy ingots to be slab-shaped with a size of 10×50×120 mm.

S2: Pre-treating and processing the alloy ingots to make alloy sample blocks.

Step S2 includes: the eight 2024 aluminum alloy ingots are homogenized in a box type resistance furnace. The heating temperature is 400-420° C. and the holding time is 12-24 hours. The alloy ingots are heated by the furnace at a heating rate of 20-30° C./min and cooled with the furnace after the holding. Then the upper and lower surfaces of each alloy ingot are machined by a fine engraving machine to ensure that the surfaces are flat and the two surfaces are parallel to each other. After processing, the thickness of each alloy ingot is 6 mm. In order to reduce the reflection of laser on the smooth surface, the surface of each alloy ingot is polished with 300# sandpaper. Finally, according to the sizes of the selective laser melting equipment and the groove thereof where the alloy ingot is placed, each alloy ingot is cut to a certain size and shaped by wire cutting, and the oil on its surface is cleaned by ultrasonic wave and dried. After above pretreatment, there come eight alloy sample blocks.

S3: Twice laser surface scanning treatment.

Step S3 includes: the eight alloy sample blocks are fixed in pre-set position of a bottom plate, and then placed in the selective laser melting equipment. The parameters of the first laser scanning are set as following: scanning speed of 300 mm/s, laser power of 200 W, and scanning spacing of 0.04 mm. In the first laser scanning, the surfaces of the eight alloy sample blocks are scanned respectively by high-energy laser beam, to form a first laser melting layer with a certain size on each alloy sample block.

After the first laser scanning, when the alloy sample blocks are completely cooled, the area of the first laser melting layer is scanned again by high-energy laser beam for the second laser scanning, with the parameters of the second laser scanning set as following: scanning speed of 300 mm/s, laser power of 200 W, and scanning spacing of 0.04 mm. And the center of the laser beam of the second laser scanning is along the centers of the two molten pools formed in the first laser melting layer, to form a second laser melting layer on each alloy sample block. The second laser melting layer is the basis to evaluate the formability, microstructure and mechanical properties of each alloy sample block.

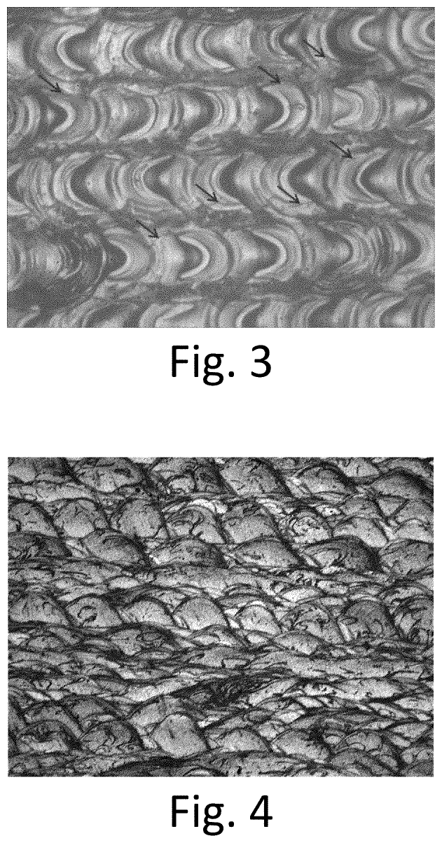

The surface morphology of the second laser melting layer of 2024 aluminum alloy is shown in FIG. 3. It can be seen from the figure that the second laser melting layer is a typical welding re-melting morphology, and there are obvious cracks (indicated by the arrows in the figure), which shows that 2024 aluminum alloy is prone to cracks during laser re-melting, indicating its formability for selective laser melting process is poor.

### Embodiment 2

This embodiment is to optimize the Mg content of Al-xMg-0.3Mn-0.6Sc-0.4Zr alloy for selective laser melting process, including the following steps:

S1: Preparing Al-xMg-0.3Mn-0.6Sc-0.4Zr alloy ingots from the raw materials.

The magnesium mass content x in Al-xMg-0.3Mn-0.6Sc-0.4Zr alloy is set to 3.0%, 3.5%, 4.0%, 4.5%, 5.0%, 5.5%, 6.0% and 6.5% respectively, and the raw materials include pure aluminum ingots, pure magnesium ingots, Al-10Mn master alloy, Al-2Sc master alloy and Al-10Zr master alloy.

Step S1 includes: according to each above formula of Al-xMg-0.3Mn-0.6Sc-0.4Zr alloy, melt the pure aluminum ingots in a resistance furnace at a temperature of 800-850° C., then add other raw materials thereto, fully stir by a graphite rod for 5-15 minutes, put a flux composed of 30% NaCl+47% KCl+23% cryolite in a graphite cover, extend it into the bottom of the melt to for slagging, use hexachlorohexane for degassing, then cool to 750-800° C., finally add 1-2% grain refiner of Al-5Ti—B, stand for 5-10 minutes to obtain Al-xMg-0.3Mn-0.6Sc-0.4Zr alloy melts with the above eight formulas respectively, and then use a copper mold for casting to reduce the composition segregation in the microstructure. The inner surface of the copper mold is pre-coated with a layer of ZnO. Eight Al-xMg-0.3Mn-0.6Sc-0.4Zr alloy ingots are made, which are then processed and cut into be slab-shaped with a size of 10×50×120 mm.

S2: Pre-treating and processing the alloy ingot to make alloy sample blocks:

Step S2 includes: the eight Al-xMg-0.3Mn-0.6Sc-0.4Zr alloy ingots are homogenized in a box type resistance furnace. The heating temperature is 400-480° C. and the holding time is 12-24 hours. The alloy ingots are heated by the furnace at a heating rate of 20-30° C./min and cooled with the furnace after the holding. Then the upper and lower surfaces of each alloy ingot are machined by a fine engraving machine to ensure that the surfaces are flat and the two surfaces are parallel to each other. After processing, the thickness of each alloy ingot is 6 mm. In order to reduce the reflection of laser on smooth surface, the surface of each alloy ingot is polished with 300# sandpaper. Finally, according to the sizes of the selective laser melting equipment and the groove thereof where the alloy ingot is placed, each alloy ingot is cut to a certain size and shaped by wire cutting, and the oil on its surface is cleaned by ultrasonic wave and dried. After above pretreatment, there come eight alloy sample blocks.

S3: Twice laser surface scanning treatment.

Step S3 includes: the eight alloy sample blocks are fixed in pre-set position of a bottom plate, and then placed in the selective laser melting equipment. The parameters of the first laser scanning are set as following: scanning speed of 300 mm/s, laser power of 200 W, and scanning spacing of 0.04 mm. In the first laser scanning, the surfaces of the eight alloy sample blocks are scanned respectively by high-energy laser beam, to form a first laser melting layer with a certain size on each alloy sample block.

After the first laser scanning, when the alloy sample blocks are completely cooled, the area of the first laser melting layer is scanned again by high-energy laser beam for the second laser scanning, with the parameters of the second laser scanning set as following: scanning speed of 300 mm/s, laser power of 200 W, and scanning spacing of 0.04 mm. And the center of the laser beam of the second laser scanning is along the centers of the two molten pools formed in the first laser melting layer, to form a second laser melting layer on each alloy sample block. The second laser melting layer is the basis to evaluate the formability, microstructure and mechanical properties of each alloy sample block.

S4: Treating the alloy sample blocks from step S3 by induction rapid heating and quenching.

In step S4, a high-frequency induction furnace is used for rapid heating, the heating temperature is 450-550° C., and the holding time is 5-60 seconds. After the holding is completed, the alloy sample blocks are quickly quenched with water to room temperature.

S5: Inspecting surface morphology, characterizing and testing microstructure and properties of the second laser melting layer of each alloy sample block from step S4, to determine whether the alloy sample blocks are suitable for selective laser melting process and optimize alloy composition.

In step S5, the surface morphology of the second laser melting layer of each alloy sample block is inspected by metallographic microscope, scanning electron microscope and energy spectrometer. The microstructure and properties of the second laser melting layer are characterized and tested by the methods of microhardness and micro-nano stretching. Specifically, by observing whether the second laser melting layer is cracked and the degree of cracking, pore size and morphology, and microstructure uniformity thereof, consequently each alloy sample block is evaluated whether it is suitable for selective laser melting forming. Through comparison and inspection, in this embodiment, of the eight Al-xMg-0.3Mn-0.6Sc-0.4Zr alloy sample blocks, those with a magnesium content of less than 6% have good formability for laser melting.

S6: Verifying experimental results.

In step S6, the Al-5Mg-0.3Mn-0.6Sc-0.4Zr alloy (that is, the x is set to 5.0%) is vacuum atomized to alloy powder, and then the alloy powder is subjected to selective laser melting process with the same process parameters as the above, and Comparison Sample 1 is formed, and the surface morphology of its laser surface melting layer and its microstructure and properties are inspected.

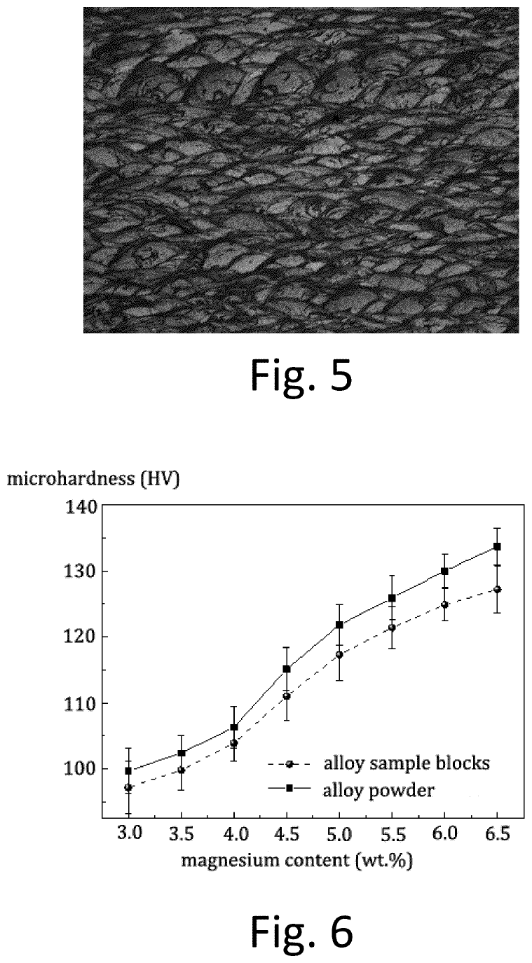

FIG. 4 shows the microstructure of the Al-5Mg-0.3Mn-0.6Sc-0.4Zr alloy sample block scanned by laser (obtained in step S5). FIG. 5 shows the microstructure of Al-5Mg-0.3Mn-0.6Sc-0.4Zr alloy powder after selective laser melting (Comparison Sample 1 obtained in step S6). It can be seen that Al-5Mg-0.3Mn-0.6Sc-0.4Zr alloy has similar periodic microstructure under the two processes, indicating that the laser surface melting and the selective laser melting have similar solidification rate and crystallization rate.

FIG. 6 shows the relationship curves between the microhardness and the Mg content of the Al-xMg-0.3Mn-0.6Sc-0.4Zr alloy sample blocks scanned by laser (obtained in step S5) and the Al-xMg-0.3Mn-0.6Sc-0.4Zr alloy powder after selective laser melting (Comparison Sample 1 obtained in step S6). It can be seen that the deviation of the microhardness of the alloy in both processes does not exceed 8%.

This experimental verification shows that the composition design optimization method in Embodiment 2 can accurately simulate and reproduce the thermal history and microstructure evolution process of selective laser melting.

### Embodiment 3

This embodiment is to optimize the Fe content of Al-xFe—V—Si alloy for selective laser melting process, including the following steps:

S1: Preparing Al-xFe—V—Si alloy ingots from the raw materials.

The iron mass content x in Al-xFe—V—Si alloy is set to 7.0%, 7.5%, 8.0%, 8.5%, 9.0% and 9.5% respectively, and the raw materials include pure aluminum ingots, pure iron rods, Fe-50V master alloy, Al-50Si master alloy and Al-10Mn master alloy.

Step S1 includes: according to each above formula of Al-xFe—V—Si alloy, melt the pure aluminum ingots in a medium-frequency induction furnace at a temperature of 800-850° C., then heat to 1100-1200° C., add other raw materials thereto, fully stir by a graphite rod for 5-15 minutes, put a flux composed of 30% NaCl+47% KCl+23% cryolite in a graphite cover, extend it into the bottom of the melt to for slagging, use hexachlorohexane for degassing, then cool to 850-900° C., and add 1-2% grain refiner of Al-5Ti—B, stand for 5-10 minutes to obtain Al-xFe—V—Si alloy melts with the above six formulas respectively, and then use a water-cooled iron mold for casting to reduce the composition segregation in the microstructure. The inner surface of the water-cooled iron mold is pre-coated with a layer of ZnO. Six Al-xFe—V—Si alloy ingots are made, which are then processed and cut into be slab-shaped with a size of 10×50×120 mm.

S2: Pre-treating and processing the alloy ingot to make alloy sample blocks:

Step S2 includes: the six Al-xFe—V—Si alloy ingots are homogenized in a box type resistance furnace. The heating temperature is 450-550° C. and the holding time is 12-24 hours. The alloy ingots are heated by the furnace at a heating rate of 20-30° C./min and cooled with the furnace after the holding. Then the upper and lower surfaces of each alloy ingot are machined by a lathe to ensure that the surfaces are flat and the two surfaces are parallel to each other. After processing, the thickness of each alloy ingot is 6 mm. In order to reduce the reflection of laser on smooth surface, the surface of each alloy ingot is polished with sandpapers of 150# and 300#. Finally, according to the sizes of the selective laser melting equipment and the groove thereof where the alloy ingot is placed, each alloy ingot is cut to a certain size and shaped by wire cutting, and the oil on its surface is cleaned by ultrasonic wave and dried. After above pretreatment, there come six alloy sample blocks.

S3: Twice laser surface scanning treatment.

Step S3 includes: the six alloy sample blocks are fixed in pre-set position of a bottom plate, and then placed in the selective laser melting equipment. The parameters of the first laser scanning are set as following: scanning speed of 300 mm/s, laser power of 200 W, and scanning spacing of 0.06 mm. In the first laser scanning, the surfaces of the six alloy sample blocks are scanned respectively by high-energy laser beam, to form a first laser melting layer with a certain size on each alloy sample block.

After the first laser scanning, when the alloy sample blocks are completely cooled, the area of the first laser melting layer is scanned again by high-energy laser beam for the second laser scanning, with the parameters of the second laser scanning set as following: scanning speed of 300 mm/s, laser power of 200 W, and scanning spacing of 0.06 mm. And the center of the laser beam of the second laser scanning is along the centers of the two molten pools formed in the first laser melting layer, to form a second laser melting layer on each alloy sample block. The second laser melting layer is the basis to evaluate the formability, microstructure and mechanical properties of each alloy sample block.

S4: Treating the alloy sample blocks from step S3 by induction rapid heating and quenching.

In step S4, a high-frequency induction furnace is used for rapid heating, the heating temperature is 450-550° C., and the holding time is 5-60 seconds. After the holding is completed, the alloy sample blocks are quickly quenched with water to room temperature.

S5: Inspecting surface morphology, characterizing and testing microstructure and properties of the second laser melting layer of each alloy sample block from step S4, to determine whether the alloy sample blocks are suitable for selective laser melting process and optimize alloy composition.

In step S5, the surface morphology of the second laser melting layer of each alloy sample block is inspected by metallographic microscope, scanning electron microscope and energy spectrometer. The microstructure and properties of the second laser melting layer are characterized and tested by the methods of microhardness and micro-nano stretching. Specifically, by observing whether the second laser melting layer is cracked and the degree of cracking, pore size and morphology, and microstructure uniformity thereof, consequently each alloy sample block is evaluated whether it is suitable for selective laser melting forming. Through comparison and inspection, the six Al-xFe—V—Si alloy sample blocks of this embodiment have good formability for laser melting.

S6: Verifying experimental results.

In step S6, the Al-xFe—V—Si alloy (wherein the x is set to 7.0%, 7.5%, 8.0%, 8.5%, 9.0% and 9.5% respectively) is vacuum atomized to alloy powder, and then the alloy powder is subjected to selective laser melting process with the same process parameters as the above, and Comparison Sample 2 is formed, and the surface morphology of its laser surface melting layer and its microstructure and properties are inspected.

The surface morphology and microstructure properties of the six alloy sample blocks fabricated in step S5 are compared with those of Comparison Sample 2 obtained in step S6, and the results shows that the deviation is less than 30%. This experimental verification shows that the aluminum alloy composition design optimization method for selective laser melting in this embodiment can accurately simulate the process of selective laser melting.

### Embodiment 4

S1: Preparing Al-7Si-xMg alloy ingots from the raw materials.

The manganese mass content x in Al-7Si-xMg alloy is set to 0.15%, 0.3%, 0.5%, 0.7%, 0.9% and 1.1% respectively, and the raw materials include pure aluminum ingots, pure magnesium ingots and Al-50Si master alloy.

Step S1 includes: according to each above formula of Al-7Si-xMg alloy, melt the pure aluminum ingots in a resistance furnace at a temperature of 800-850° C., then add other raw materials thereto, fully stir by a graphite rod for 5-15 minutes, put a flux composed of 30% NaCl+47% KCl+23% cryolite in a graphite cover, extend it into the bottom of the melt to for slagging, use hexachlorohexane for degassing, then cool to 700-750° C., and add 1-2% grain refiner of Al-5Ti—B, stand for 5-10 minutes to obtain Al-75i-xMg alloy melts with the above six formulas respectively, and then use a copper mold whose inner surface is pre-coated with a layer of ZnO for casting. Six Al-7Si-xMg alloy ingots are made, which are then processed and cut into be slab-shaped with a size of 10×50×120 mm.

S2: Pre-treating and processing the alloy ingot to make alloy sample blocks:

Step S2 includes: the six Al-7Si-xMg alloy ingots are homogenized in a box type resistance furnace. The heating temperature is 400-480° C. and the holding time is 12-24 hours. The alloy ingots are heated by the furnace at a heating rate of 20-30° C./min and cooled with the furnace after the holding. Then the upper and lower surfaces of each alloy ingot are machined by a fine engraving machine to ensure that the surfaces are flat and the two surfaces are parallel to each other. After processing, the thickness of each alloy ingot is 6 mm. In order to reduce the reflection of laser on the smooth surface, the surface of each alloy ingot is polished with 300# sandpaper. Finally, according to the sizes of the selective laser melting equipment and the groove thereof where the alloy ingot is placed, each alloy ingot is cut to a certain size and shaped by wire cutting, and the oil on its surface is cleaned by ultrasonic wave and dried. After above pretreatment, there come six alloy sample blocks.

S3: Twice laser surface scanning treatment.

Step S3 includes: the six alloy sample blocks are fixed in pre-set position of a bottom plate, and then placed in the selective laser melting equipment. The parameters of the first laser scanning are set as following: scanning speed of 300 mm/s, laser power of 200 W, and scanning spacing of 0.4 mm. In the first laser scanning, the surfaces of the six alloy sample blocks are scanned respectively by high-energy laser beam, to form a first laser melting layer with a certain size on each alloy sample block.

After the first laser scanning, when the alloy sample blocks are completely cooled, the area of the first laser melting layer is scanned again by high-energy laser beam for the second laser scanning, with the parameters of the second laser scanning set as following: scanning speed of 300 mm/s, laser power of 200 W, and scanning spacing of 0.4 mm. And the center of the laser beam of the second laser scanning is along the centers of the two molten pools formed in the first laser melting layer, to form a second laser melting layer on each alloy sample block. The second laser melting layer is the basis to evaluate the formability, microstructure and mechanical properties of each alloy sample block.

S4: Treating the alloy sample blocks from step S3 by induction rapid heating and quenching.

In step S4, a high-frequency induction furnace is used for rapid heating, the heating temperature is 450-550° C., and the holding time is 5-60 seconds. After the holding is completed, the alloy sample blocks are quickly quenched with water to room temperature.

S5: Inspecting surface morphology, characterizing and testing microstructure and properties of the second laser melting layer of each alloy sample block from step S4, to determine whether the alloy sample blocks are suitable for selective laser melting process and optimize alloy composition.

In step S5, the surface morphology of the second laser melting layer of each alloy sample block is inspected by metallographic microscope, scanning electron microscope and energy spectrometer. The microstructure and properties of the second laser melting layer are characterized and tested by the methods of microhardness and micro-nano stretching. Specifically, by observing whether the second laser melting layer is cracked and the degree of cracking, pore size and morphology, and microstructure uniformity thereof, consequently each alloy sample block is evaluated whether it is suitable for selective laser melting forming. Through comparison and inspection, the six Al-7Si-xMg alloy sample blocks of this embodiment have good formability for laser melting.

S6: Verifying experimental results.

In step S6, the Al-7Si-xMg alloy (wherein the x is set to 0.15%, 0.3%, 0.5%, 0.7%, 0.9% and 1.1% respectively) is vacuum atomized to alloy powder, and then the alloy powder is subjected to selective laser melting process with the same process parameters as the above, and Comparison Sample 3 is formed, and the surface morphology of its laser surface melting layer and its microstructure and properties are inspected.

The surface morphology and microstructure properties of the six alloy sample blocks fabricated in step S5 are compared with those of Comparison Sample 3 obtained in step S6, and the results shows that the deviation is less than 20%. This experimental verification shows that the aluminum alloy composition design optimization method for selective laser melting in this embodiment can accurately simulate the process of selective laser melting.

Compared with the known art, the composition design optimization method of the disclosure adopts two laser surface scanning processing combined with induction rapid heating, according to the characteristics of the alloy material's melting, solidification and thermal history in the process of selective laser melting, making the microstructure of the second laser melting layer on the surface of the alloy sample block closer to the alloy powder that is rapidly solidified during the selective laser melting process, and at the same time, the thermal stress of the laser melting layer is closer to the thermal in the selective laser melting process, thereby simulating the state of alloy material in the process of selective laser melting. Then the obtain second laser melting layer thereon is inspected and analyzed, and its microstructure performance is tested, so as to accurately analyze and decide whether the composition of the alloy sample block is right for selective laser melting forming technology. In addition, the composition design optimization method of the present disclosure has simple steps, directly analyzing the alloy ingot without making it to powder, which simplifies the screening and optimization steps, and can perform rapid evaluation of multiple alloy ingots at the same time, realizing a highly efficient alloy composition design optimization for selective laser melting, which provides a new idea and new method in the area thereof.

Although the disclosure is disclosed in the form of preferred embodiments and variations thereon, it will be understood that numerous additional modifications and variations could be made thereto without departing from the scope of the present application.

What is claimed:

1. A composition design optimization method of aluminum alloy for selective laser melting, comprising the following steps:
S1: preparing raw materials according to different designed formulas, and making alloy ingots with different composition;
S2: pre-treating and processing the alloy ingots to obtain alloy sample blocks with different composition;
S3: using high-energy laser beam perform on surface of each alloy sample block for first laser scanning to form a first laser melting layer on the surface thereof, then using high-energy laser beam again to perform on area of the first laser melting layer for second laser scanning to form a second laser melting layer;
S4: treating the alloy sample blocks from the step S3 by induction heating and quenching;
S5: inspecting surface morphology, characterizing and testing microstructure and properties of the second laser melting layer of each alloy sample block from the step S4, to determine whether the alloy sample blocks are suitable for selective laser melting process and optimize composition of the alloy sample blocks.

2. The composition design optimization method of claim 1, wherein in the step S3, when the alloy sample blocks are completely cooled after the first laser scanning, the second laser scanning is performed.

3. The composition design optimization method of claim 2, wherein in the step S3, a center of the laser beam of the second laser scanning is scanned along centers of two molten pools formed in the first laser melting layer.

4. The composition design optimization method of claim 3, wherein in the step S3, before the first laser scanning, the surface of each alloy sample block is subjected to laser scanning pretreatment, and then process parameters of the first laser scanning and the second laser scanning are determined by observing state of a laser surface melting layer obtained by the laser scanning pretreatment.

5. The composition design optimization method of claim 4, wherein in the step S3, steps of the first laser scanning and the second laser scanning comprise: placing the alloy sample blocks in prefabricated fixtures of a selective laser melting equipment, and setting scanning speed to 10-600 mm/s, laser power to 50-300 W, and scanning spacing to 0.05-0.1 mm for scanning.

6. The composition design optimization method of claim 5, wherein in the step S3, the prefabricated fixtures are grooves machined on a substrate of the selective laser melting equipment, matching dimensions of the alloy sample blocks, with a height of 2 mm.

7. The composition design optimization method of claim 6, wherein the step S4 specifically comprises: transferring the alloy sample blocks from the step S3 to a high-frequency induction furnace, using the high-frequency induction furnace for heating with a heating temperature of 450-550° C., and holding time of 5-60 seconds, and quenching the alloy sample blocks with water to room temperature after holding.

8. The composition design optimization method of claim 7, wherein in the step S1, making each alloy ingot comprises: preparing raw materials, mixing pure metals, master alloys and smelting aids, and then smelting to obtain an alloy melt; a method of smelting is any one of resistance furnace smelting, induction smelting, and vacuum smelting; then casting the alloy melt with a mold with a flat cavity to form a slab-shaped alloy ingot.

9. The composition design optimization method of claim 8, wherein in the step S2, pre-treating and processing each alloy ingot comprises: homogenizing the alloy ingot, and then processing and cutting the alloy ingot to form a round alloy sample block with a thickness of 5-10 mm and a diameter of 20-30 mm.

10. The composition design optimization method of claim 9, wherein in the step S5, according to cracking degree, pore size, morphology and microstructure uniformity of the second laser melting layer of each alloy sample block, whether the alloy sample block with designed formula is suitable for selective laser melting process is evaluated, and microstructure and properties of the second laser melting layer of the alloy sample block and alloy powder with the same formula after selective laser melting are compared, to optimize composition of aluminum alloy for selective laser melting process.
